(19) United States
(12) Patent Application Publication
(10) Pub. No.: US 2003/0168479 A1
(43) Pub. Date: Sep. 11, 2003

(54) Method and apparatus for dispensing a fluid

(75) Inventors: Richard Lu, Alpharetta, GA (US); Kai Su, Alpharetta, GA (US)

Correspondence Address: Merchant & Gould P.C., P.O. Box 2903, Minneapolis, MN, 55402-0903, US

(73) Assignee: Technology Resource International Corporation

(21) Appl. No.: 10/095,130

(22) Filed: Mar. 11, 2002

(51) Int. Cl. B67D 5/42

(52) U.S. Cl. 222/386

(57) ABSTRACT

A fluid-dispensing device and method of dispensing fluid comprising a container for holding the fluid, a housing having an interior in which a portion of the container is located, and a source for compressing a portion of the container disposed within the interior of the housing. When the container is compressed, the fluid exits the container to flow to a desired location. The methods of compressing the container to force the fluid out of its interior include, for example, a housing holding the container that is pressurized above atmospheric pressure; an expandable balloon positioned adjacent the container and inflated; and a plate driven by a cylinder to compress the container. It is noted that this abstract is provided to comply with the rules requiring an abstract that will allow a searcher or other reader to ascertain quickly the subject matter of the technical disclosure. The abstract is submitted with the understanding that it will not be used to interpret or limit the scope or meaning of the claims pursuant to 37 C.F.R. §1.72(b).

### BACKGROUND OF THE INVENTION

1. Field of the Invention

The present invention relates to a method and apparatus for dispensing fluids and, more particularly, to a method and apparatus for dispensing viscous liquids, such as monomer.

2. Background

Many manufacturing processes require fluids to be dispensed or injected in a controlled manner. As one skilled in the art appreciates, controllably injecting viscous liquids often presents more challenges than less viscous fluids. An example of an industry that faces such challenges is the ophthalmic industry, which is involved in forming eyeglass lenses, contact lenses, and telescope and binocular lenses. Such lenses are typically formed in a molding process, in which a viscous lens-forming fluid, such as liquid monomer, is placed into a cavity of a lens-mold assembly defined by two molds and a gasket, after which the monomer subsequently cured into a polymeric structure.

Problems that arise while dispensing liquid monomer into the lens mold assembly often result in defects in the final lens. For example, since the monomer is typically pumped from an open container through a dispensing pipe or tube into the lens mold cavity, air can mix with or otherwise become trapped within the monomer, potentially resulting in unacceptable bubbles or chemical changes within the final lens product. Another potential problem is that contamination, such as dust or other debris, sometimes becomes lodged in the piping and is introduced into the monomer, thus appearing in the final product.

Another potential problem is that premature curing may occur of monomer remaining inside the piping, which is caused by heat generated by mechanical pumping devices or simply from heat absorption that occurs over time. This premature curing results in dispensing operations being halted until the line is unclogged. Similarly, when a change of monomer type is made between manufacturing processes, removal of all traces of the prior monomer type existing in the dispensing pipe or tube is usually necessary. Therefore, before each different monomer is used, it is often necessary to remove all extraneous monomer trapped in the dispensing piping by purging it with chemical solvents. This purging, however, is time consuming, messy, and produces chemical waste.

To address these issues, lens-manufacturing processes have traditionally been performed in a large-scale, clean room manufacturing environment. Correspondingly, smaller-scale operations, such as in a doctor's office or the store of an eyeglass vendor, are uncommon.

### SUMMARY OF THE INVENTION

The present invention provides a fluid-dispensing device and method of dispensing fluid. The present invention includes a container for holding the fluid, a housing having an interior in which a portion of the container is located, and a means for compressing a portion of the container disposed within the interior of the housing. When the container is compressed, the fluid exits the container to enter a desired location, such as a lens-forming assembly to make a lens. Methods of compressing the container to force the fluid out of its interior include, for example, a housing holding the container that is pressurized above atmospheric or ambient pressure; an expandable balloon positioned adjacent the container and inflated; and a plate driven by a cylinder to compress the container.

The present invention, as one skilled in the art will further appreciate, minimizes the amount of ambient air or other gases contacting the dispensed fluid because the container holding the fluid is sealed from atmosphere. Likewise, the present invention minimizes the amount of dirt, extraneous monomer, or other contamination that may potentially accumulate in the dispensing tube.

As one skilled in the art will appreciate, the present invention is relatively simple to operate, yet allows controlled dispensing of fluids held within the container. The dispensed fluid is not itself pumped, which reduces heating of the fluid and further minimizes the chances that impurities will mix with the fluid being dispensed. Also, in the exemplary embodiment of the present invention discussed above, changing between fluids being dispensed is relatively easy (i.e., changing the container and associated tubing), as opposed to flushing out or purging pipes and tubes that interconnect with a pumping source during or between manufacturing operations.

The method and apparatus of the present invention also allows for a clean, cost effective way to manufacture optical lenses in a standard office-type environment. The need for clean room and chemical waste disposal facilities are eliminated or greatly reduced. Depending on the design of the present invention, it additionally may be less expensive than other fluid dispensing technologies. Thus, using the present invention to form optical lenses makes more feasible the installation of a lens-forming device in a doctor's or an eyeglass vendor's office.

### BRIEF DESCRIPTION OF THE FIGURES OF THE DRAWINGS

FIG. 1 is a perspective view of an apparatus for dispensing fluids according to a first embodiment of the present invention.

FIG. 2 is a perspective view of a bag assembly used as part of the apparatus according to the first embodiment of the present invention shown in FIG. 1.

FIG. 3 is a perspective view of a second embodiment of an apparatus for dispensing fluids of the present invention.

FIG. 4 is a cross-sectional view of an apparatus for dispensing fluids according to the second embodiment of the present invention shown in FIG. 3.

FIG. 5 is a perspective view of an apparatus according to a third embodiment of the present invention.

FIG. 6 is a side view, partially in cross-section, of FIG. 5.

FIG. 7 is also a side view, partially in cross-section, showing an alternative design of the third embodiment illustrated in FIGS. 5 and 6.

FIG. 8 is a perspective view of an apparatus according to a fourth embodiment of the present invention.

FIG. 9 is a side view, partially in cross-section, of FIG. 8.

### DETAILED DESCRIPTION OF THE INVENTION

The present invention is more particularly described in the following examples that are intended as illustrative only since numerous modifications and variations therein will be apparent to those skilled in the art. As used in the specification and in the claims, “a,” “an,” or “the” can mean one or more, depending upon the context in which it is used.

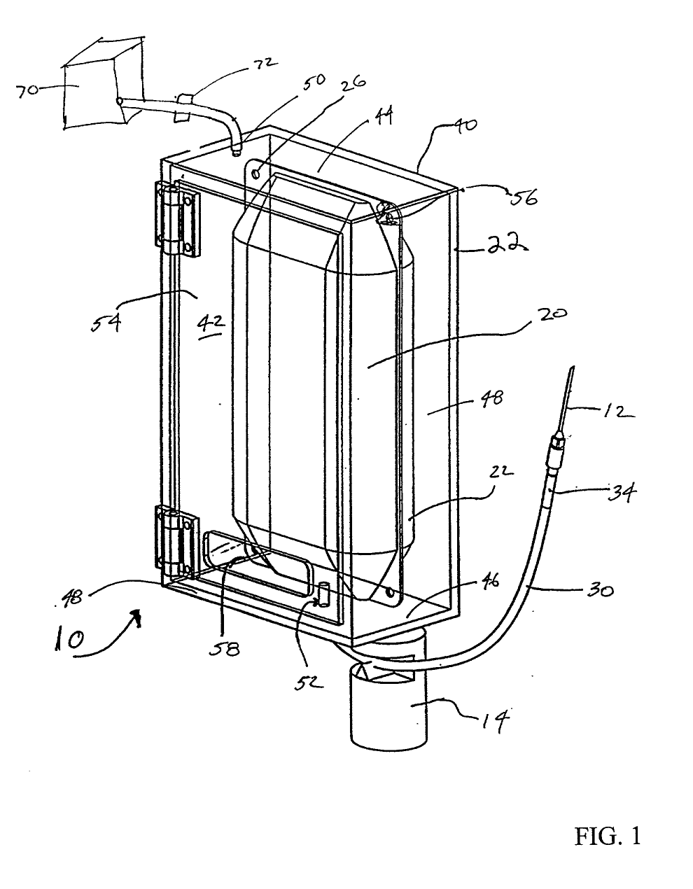

FIGS. 1-9 show exemplary embodiments and designs of present invention, which comprises a fluid-dispensing device 10 and method of dispensing fluid. In general, the present invention includes a container 20 for holding the fluid, a housing 40 having an interior 42 in which a portion of the container 20 is located, and a means for compressing a portion of the container 20 disposed within the interior 42 of the housing 40. The preferred embodiments are now described in more detail below with reference to these figures, in which like numbers indicate like parts throughout.

The illustrated embodiments are discussed in the context of dispensing a lens forming fluid, specifically monomer, which is viscous liquid. Monomer dispersed from the container 20 is injected into an optical lens in a mold (not shown), and an example of a mold assembly useful in conjunction with the present invention is disclosed in U.S. Pat. No. 6,099,764, which is incorporated herein in its entirety by reference. Those skilled in the art will appreciate, however, that the present invention has application to dispensing other fluids, including both gases and liquids.

Prior to dispensing operations, the fluid (e.g., monomer in one exemplary embodiment) is added into the container 20 through the outlet 24 or other sealable orifice (not shown). The container 20 is sealed from ambient, which prevents the introduction of air, other fluids, or other contaminants surrounding the exterior of the container 20 from mixing with the fluid held within the container 20. One skilled will appreciate that in addition to the container 20 being impermeable to contaminants, it should also be strong enough not to break when the compressing source exerts a force on the container 20 to cause the internal pressure to increase and dispense the fluid held within the container 20.

At least a portion of the surface 22 of the container 20 is deformable, flexible, or collapsible. For the container 20 illustrated in FIGS. 1-9, substantially the entire surface 22 of the container 20 is deformable. One potential material of which the deformable portion of the container 20 may be formed is low-density polyethylene; however, any material that is sufficiently deformable, that can withstand the chemical properties of the fluid held therein, and that is capable of enduring the pressurized environment resulting from the compressing means may be employed. Although not presently preferred, it is contemplated that multiple materials may be used, some deformable and others rigid.

As illustrated in FIGS. 1-9, the outlet 24 of the container 20 is shown disposed at its lower portion, specifically, at its bottom. Although this positioning of the outlet 24 is not necessary, one skilled in the art will appreciate that it is beneficial for gravity to assist—instead of opposing—flow of the fluid out of the container 20.

As also illustrated, the outlet 24 is also connected to and in fluid communication with a first end 32 of a dispensing tube 30. The dispensing tube 30 has an opposed second end 34 that is in fluid communication with a needle 12, which is provided in the exemplary embodiment for inserting into the mold cavity (not shown). Thus, when fluid exits out of the outlet 24 of the container 20, it enters the dispensing tube 30 through its first end 32, travels therethrough, and then exits out of the second end 34 via the attached the needle 12.

In the illustrated embodiments, the dispensing tube 30 is of sufficient length so that it extends through the interior 42 of the housing 40 and its second end 34 is located outside of the interior 42. The shape and diameter of the dispensing tube 30 should be chosen to promote laminar flow of the fluid held within the container 20 through its length. To avoid pinching of the dispensing tube 30 during use, it is preferable that the dispensing tube 30 be made from a material that is not subject to, or resistant to, deforming in the pressure exerted from the compression source that is applied to the container 20. A semi-rigid plastic, such as medium-density polyethylene, may be used. Alternatively, the dispensing tube 30 may be made with the same material as the container 20 but with relatively thicker walls. The dispensing tube 30 is also preferably clear or translucent to allow viewing or inspection of the fluid as it passes through and along its length.

FIGS. 1 and 5-9 also show a valve 14 in communication with the dispensing tube 30 intermediate its first and second ends 32, 34. The valve 14, which is preferably located outside the interior 42 of the housing 40, may be used for controlling the flow of fluid out of the dispensing tube 30. Specifically, the valve 14 is movable between a shut position, in which fluid is hindered from traversing through the dispensing tube 30, and an open position, in which fluid flow more freely occurs through the dispensing tube 30. Although one design of the valve 14 is shown, those skilled in the art will appreciate various types can be used, including globe-type valves that stop and allow flow.

The housing 40, as noted above, has an interior 42 where at least a portion of the container 20 is located and, more specifically, where at least a portion of the deformable surface 22 of the container 20 is located. As one skilled in the art will appreciate, the housing 40 may take different shapes. FIGS. 1 and 5-9 show the housing 40 being a cubical or rectangular structure with a top 44, a bottom 46, and four interconnecting walls 48, but one skilled in the art will appreciate that other shapes are viable. Examples include cylindrical, spherical, and polygonal shapes or volumes. Also, all the illustrated embodiments show the presently preferred embodiment in which the entire container 20 is fully disposed within the interior 42 of the housing 40, but as one skilled in the art will appreciate, it is not necessary that the container 20 be fully contained within the interior 42 to fall within the scope of the present invention.

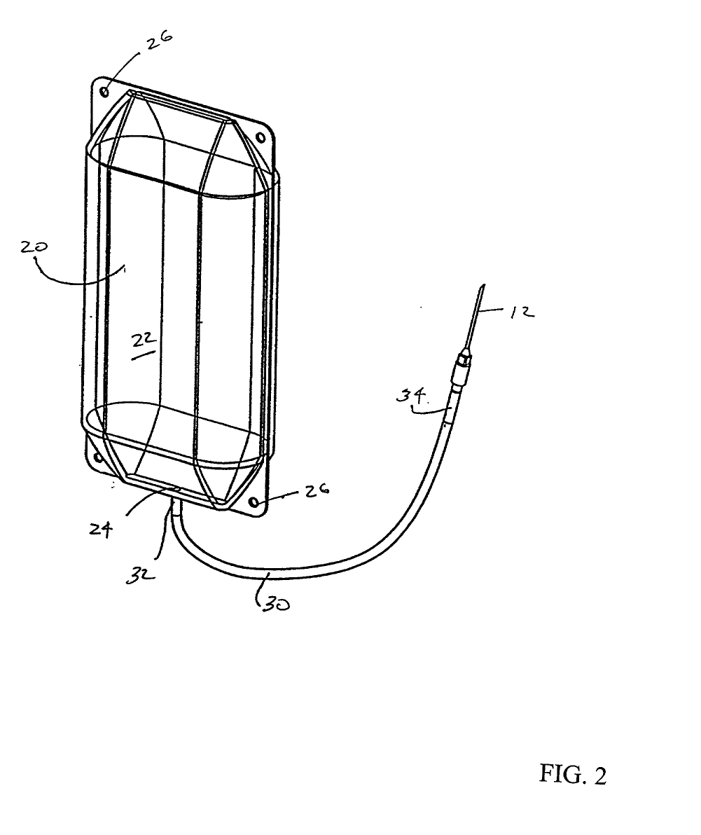

The method or means to compress the deformable portions of the container 20 may embody different forms, and the design of the housing 40 may change accordingly. Initially discussing a first embodiment of the present invention shown in FIGS. 1 and 2, the interior 42 of the housing 40 is a closed and substantially fluid-tight volume. A pressurized fluid source 70, which is shown schematically and discussed in more detail below, is in fluid communication with the inlet orifice 50 and used to compress the deformable portions of the container 20 by increasing the pressure within the interior 42 of the housing 40.

Addressing in more detail the housing 40 used with this first embodiment, it is rectangular (but as noted above may take different alternative forms). Specifically, the housing 40 has a top 44, a spaced-apart bottom 46, and a plurality of walls 48 abutting each other and interconnecting the top 44 and bottom 46 so that, collectively, the housing 40 is air impermeable and rigid. Metal or high-density polyethylene is the preferred material for the walls 48, although a rigid plastic may be used in the event the housing 40 is to be disposable.

The housing 40 includes an inlet orifice 50, which is preferably provided through the top 44 of the housing 40. The inlet orifice 50 allows pressurized fluid from the pressurized fluid source 70, such as air, another gas, or a liquid such as water, to flow through it into the interior 42 where the container 20 is located. Additionally, the housing 40 also preferably includes a sealable aperture 52 through which a portion of the dispensing tube 30 intermediate its first and second ends 32, 34 is disposed. This sealable aperture 52 is preferably provided through the bottom 46 of the housing 40.

Referring still to FIG. 1, one of the walls 48 of the housing 40 includes a sealable door 54 that is movable between an open position, in which the container 20 may be accessed within the interior 42 of the housing 40, and a shut position, in which the interior 42 is substantially sealed from ambient. That is, when the door 54 is in the shut position as shown in FIG. 1, the housing 40 is sealed to hold a positive fluid pressure within its interior 42. If the housing 40 is made of metal or other material that is not transparent, a clear viewing window 58 may be used to see the interior 42 when the door 54 is in the shut position.

Accessing the interior 42 of the housing 40 through the door 54, the operator can position the container 20 within its interior 42. One or more brackets 56 (which may include standard-type screws or other fastening means) may attach to the top 44 or upper wall 48 of the housing 40, which are in turn are capable of being removably fastened to hanging points 26 on the container 20. Also attaching the container 20 to brackets 56 positioned at the lower portion of the housing 40 is also an option. The first end 32 of the dispensing tube 30 is also connected to the outlet 24 of the container 20 and the dispensing tube 30 is disposed through the sealable aperture 52. After the container 20 is positioned and the door 54 is moved to its shut position, then the container 20 within the sealed interior 42 may be surrounded by fluid from the pressurized fluid source 70 entering through the inlet orifice 50.

The pressurized fluid source 70 can take numerous forms known in the art, such as a source of pressurized air or other gas, which may be embodied as an air compressor, a compressed gas cylinder or tank, and the like. Alternatively, the pressurized fluid source 70 may include a water pump or the similar device that injects a liquid into the interior 42 of the housing 40 through the inlet orifice 50.

When fluid from the pressurized fluid source 70 is added into the interior 42 of the housing 40 through its inlet orifice 50, pressure within the interior 42 increases. The deformable surface 22 of the container 20 moves inwardly toward its opposed surface, causing the fluid within the container 20 to be forced through its outlet 24 to enter the dispensing tube 30 and traverse toward its second end 34. Since the container 20 is sealed from ambient and the pressure applied to the surface 22 of the container 20 can be controlled, air bubbles and other distortions in the dispensed fluid are minimized. Also, since the fluid is not pumped in this design, less heat is added to the fluid as it traverses from its storage location (i.e., the container 20) to its destination (i.e., the mold).

It is also preferred to use a regulating device 72, such as an air regulator if compressed air is used, to control the amount of fluid injected or added into the interior 42 of the housing 40. The regulating device 72 should be capable of ensuring that constant positive pressure is maintained within the interior 42 of the housing 40 sufficient to compensate for the loss of fluid in the container 20 as the container is deformed when the fluid it holds is dispensed out of its outlet 24.

With the components of the first embodiment outlined, the method of operation of one specific design is discussed. A tank of compressed air 70 is placed in fluid communication with the inlet orifice 50, and air is controllably delivered to the housing 40 until a desired pressure is achieved inside the interior 42. The dispensing needle 12 is placed into the cavity of the mold (not shown). As noted above, the present invention is described in the context of dispensing a viscous liquid, namely, monomer, in a lens forming process. As disclosed in U.S. Pat. No. 6,099,764, the lens forming assembly is formed from an elastomeric strip wrapped around the edges of two molds to form a sleeve-like structure, which in turn cooperates with the molds to form a molding cavity. To inject the monomer, the needle 12 attached to the second end 34 of the dispensing tube 30 pieces through the sleeve-like structure to communicate with the cavity of the mold. The elastomeric character of the sleeve-like structure also insures that no unnecessary air is introduced to the cavity. However, it should be understood that the present invention may also be used with other types of molding assemblies, as well as with other processes with which a controlled injection of fluid is desired or required.

With the tip of the needle 12 positioned within and in fluid communication with the mold and with the interior 42 of the housing pressurized, the valve 14 is placed in its open position. The positive pressure within the interior 42 of the housing 40 surrounding the container 20 causes its surface 22 to deform by collapsing inwardly toward the opposed surface. Deformation of portions of the surface 22 forces the monomer within the container 20 through the dispensing tube 30 and then out the needle 12.

To avoid inconsistent flow rates of monomer from the container 20 and out through the needle 12 and to minimize the presence of bubbles and distortions in the final lens product, it is desirable that a consistent flow of monomer through the dispensing tube 30 be maintained throughout injecting operations. To achieve such a flow in this design, air is continually added into the interior 42 of the housing 40 through the inlet orifice 50 in an amount required to compensate for the volume of monomer exiting the container 40. As noted above, the regulator 72 may be used to control automatically the pressure within the interior 42 to achieve a substantially constant velocity, pressure, and other flow properties of the monomer as it travels from the container 20, through the dispensing tube 30, and out the needle 12 into the mold. To further automate the process, a controller, such as an electronic processing unit (not shown), may be used for controlling the valve 14 to start and stop the flow of the monomer and also for controlling the pressure within the interior 42 of the housing 40 via the pressurized fluid source 70 and the regulator 72.

One skilled in the art will further appreciate that other designs of the first embodiment of the present invention may be used. For example, although not preferred, the entire surface 22 of the container 20 is not necessarily deformable. As another example, the entire container 20 does not need to be disposed within the interior 42 of the housing 40, but as one skilled in the art will appreciate, the interior 42 must be substantially fluid-tight so that there is no communication (i.e., leakage) to ambient when the pressurized fluid is introduced therein.

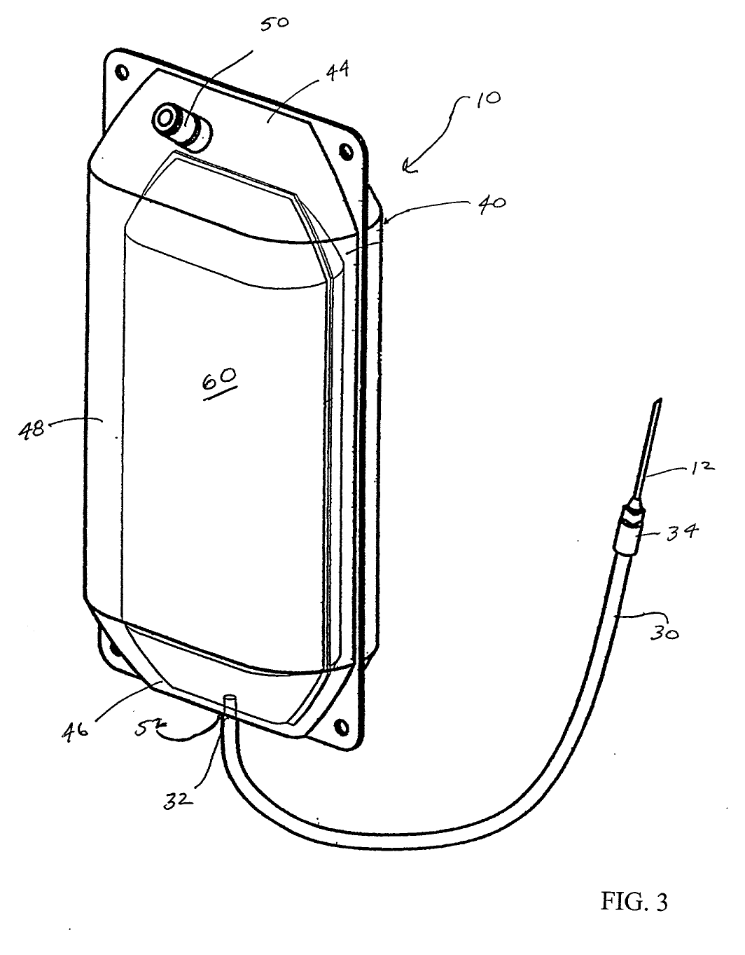

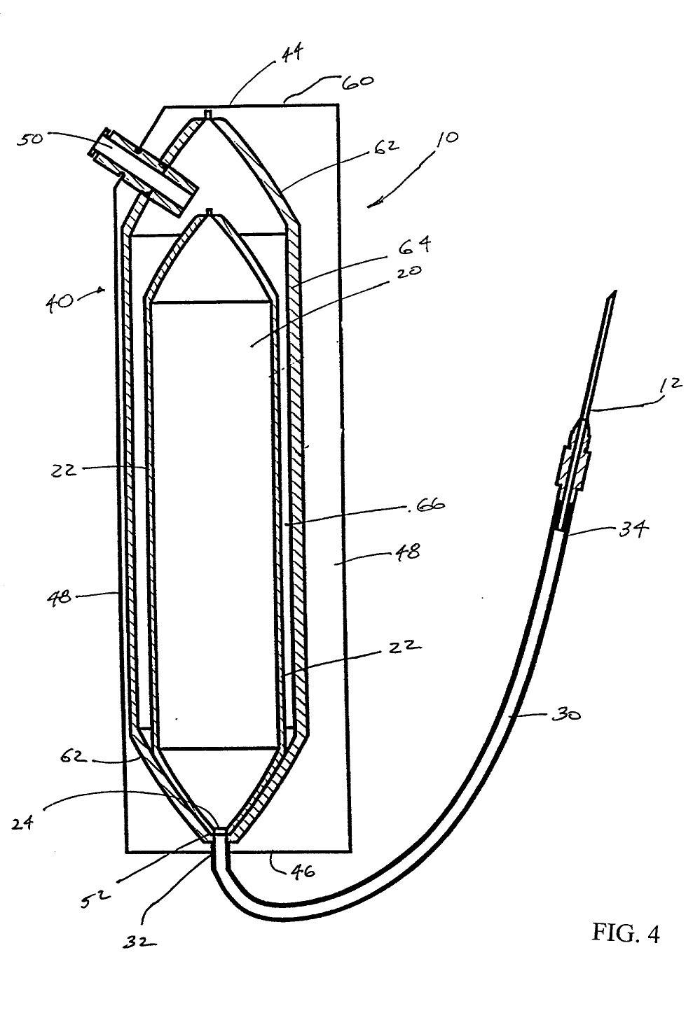

As another variation, a second embodiment of the present invention is shown in FIGS. 3 and 4 that includes an outer shell 60 and a liner 64. The outer shell 60 has an inside surface 62 and the liner 64 is disposed within and substantially circumscribed by that inside surface 62 of the outer shell 60. The liner 64 forms the closed volume of the housing 40 in which the container 20 is positioned. The outer shell 60 is preferably formed of a substantially rigid material and the liner 64 is formed of a flexible and fluid-impervious material. Thus, the outer shell 60 does not need to be sealable; rather, the liner 64 is capable of holding the pressurized fluid injected by the pressurized fluid source.

Similar to the first embodiment shown in FIGS. 1 and 2, the inlet orifice 50 is in fluid communication with the interior 66 of the liner 64 and allows fluid to be controllably added into the interior 66 of the liner 64 from the pressurized fluid source. Likewise, the dispensing tube 30 extends through the liner 64 through a sealable aperture 52 and preferably through and out the outer shell 60.

In the method of using the second embodiment shown in FIGS. 3 and 4, pressurized fluid is injected into the interior 66 of the liner 64 through the inlet orifice 50. The liner 64, accordingly, acts in a similar manner as the interior 42 of the housing in the first described embodiment by holding a controllable positive fluid pressure against the deformable surface 22 of the container 20. As that positive pressure pushes against the surface 22, fluid held within the container 20 is dispensed through the dispensing tube 30. Because the positive fluid pressure is contained within the fluid impervious liner 64, there is no need for the surrounding container 20 to be sealable or made from expensive material. This advantageously enables the device 10 to be disposable. However, similar to the other embodiments, this design likewise minimizes distortions in the dispensed fluid, such as air bubbles.

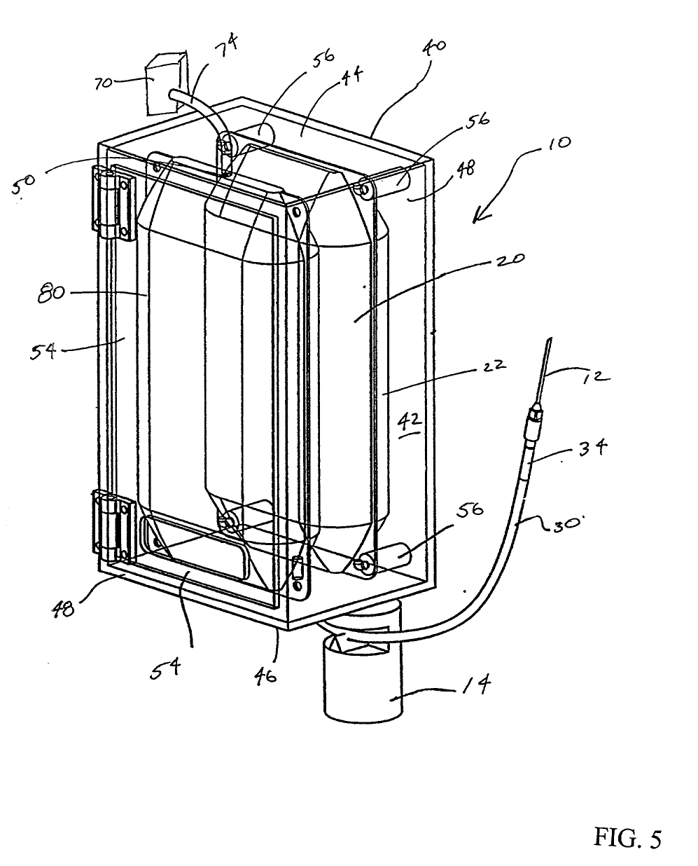

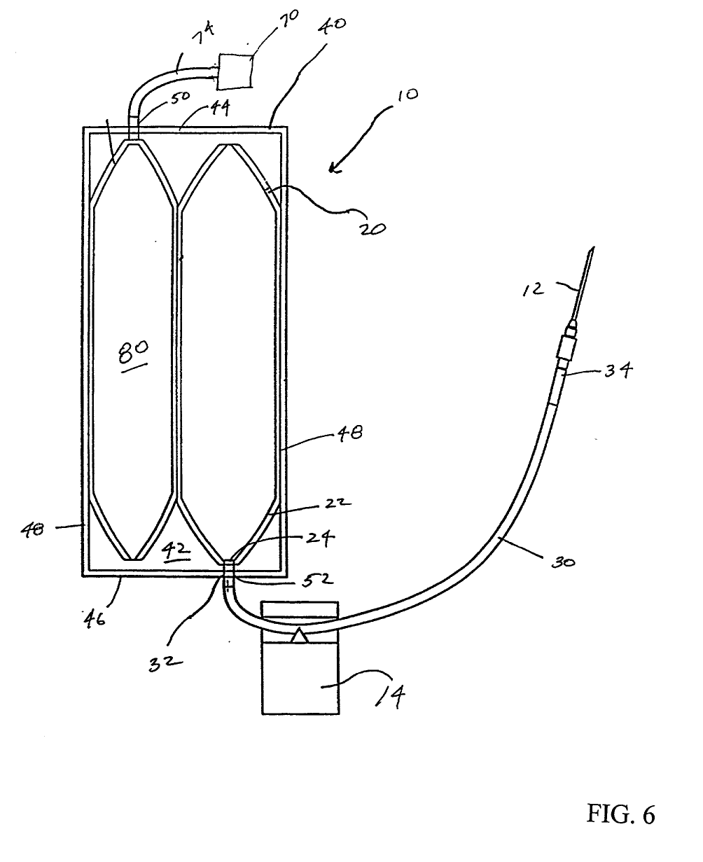

For other embodiments of the present invention, it may not be necessary to use a fluid-tight or sealed housing 40. Referring now to FIGS. 5 and 6, a third embodiment of the present invention is shown. The method or means to compress the container 20 comprises at least one inflatable balloon 80 (or other inflatable structure) and a pressurized fluid source 70 in fluid communication with the balloon 80. The balloon 80 is at least partially disposed within the interior 42 of the housing 40 adjacent the container 20. Also, the balloon 80 may be similar to the liner 64 discussed above for FIGS. 3 and 4, e.g., the balloon 80 is fluid-impervious and is thus capable of being inflated with air, other gases, water, or other liquids. The balloon 80 may be formed of rubber, elastic polymer, or any other material that will allow it to inflate and, preferably, a material that will not stick to or otherwise adversely affect the surface 22 of the container 20.

The housing 40, as noted above, does not need to be sealable in this embodiment. In fact, the housing 40 may be as simple as opposed walls 48 that stationarily position the balloon 80 and container 20 relative to each other. Thus, when the balloon 80 expands and is maintained at its relative position by its adjacent wall 48, the balloon 80 compresses the container 20, which is also held stationarily by its respective adjacent wall 48, which is opposed to the wall positioning the balloon 80. It is also advantageous to have a bottom 46 to interconnect the walls 48 of the housing 40. FIGS. 5 and 6, however, illustrate that the housing 40 is similar to the design of the first embodiment, shown in FIGS. 1 and 2. That is, the housing 40 has a bottom 46, a top 44, four walls 48, an inlet orifice 50 and aperture 52 through which the dispensing tube 30 is disposed, but as noted above, the interior 42 does not need to be sealable from ambient. A conduit 74 interconnects the inflatable balloon 80 and the pressurized fluid source 70 through the inlet orifice 50. As described in the previous embodiments, a regulator may control the volume and pressure of fluid provided to the balloon 80.

In use, the container 20 holding the fluid to be dispensed is positioned within the interior 42 of the housing 40 between the balloon 80 and a wall 48 of the housing 40. Air or another fluid from the pressurized fluid source 70 is injected or added into the balloon 80 through the conduit 74, causing the balloon 80 to inflate. The wall 48 of the housing 40 having the door 54 stationarily positions the balloon 80 relative to the container 20 as it inflates and the container is squeezed or “sandwiched” between its adjacent wall 48 and the inflating balloon 80. The deformable surfaces 22 of the compressed container 20, accordingly, are forced inwardly as the balloon 80 continues to expand, forcing the fluid therein from its outlet 24 and through the dispensing tube 30, if attached, and out of the attached needle 12. That is, fluid from the pressurized fluid source 70 expands the balloon 80, which correspondingly compresses a portion of the deformable surface 22 of the container 20 located within the interior 42 of the housing 40 inwardly so that fluid within the container 20 is forced through its outlet 24. A controlled, consistent flow of the fluid from the container 20 is achieved by adding additional fluid to the balloon 80 to compensate for the volume of fluid leaving the container 20.

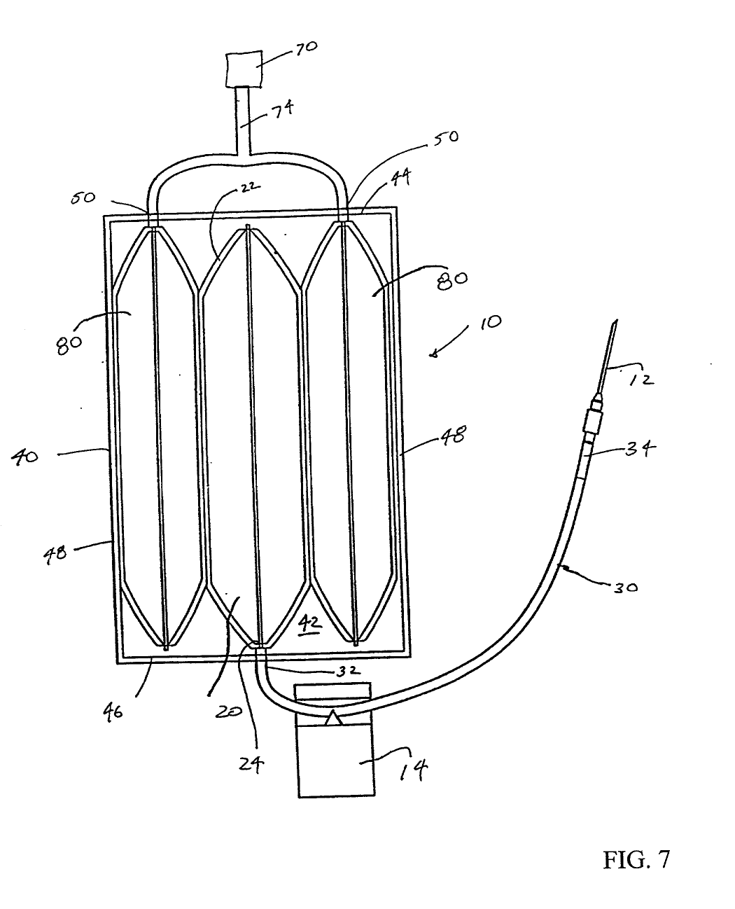

Referring now to FIG. 7, an alternative design of the third embodiment is shown. As will be noted, there are two balloons 80 and the container 20 is disposed intermediate those two balloons 80. The pressurized fluid source 70 is in fluid communication with both balloons 80 via the conduit 74 that branches, although separate pressurized fluid sources (not shown) can be used for each respective balloon 80. As illustrated, one balloon 80 is placed adjacent respective opposed surfaces 22 of the container 20 such that both balloons 80 each contact the surface 22 of the container 20. These balloons 80 also contact the walls 48 of the housing 40. As with the design shown in FIGS. 5 and 6, fluid is provided to the two balloons 80 shown in FIG. 7 through the conduit 74, which inflates the balloons 80 and causes the surface 22 of the container 20 to be forced inwardly toward the opposed surface 22. The balloons 80, accordingly, “sandwich” and deform or constrict the container 20, creating an internal pressure that dispenses the fluid (e.g., liquid monomer in one design) in the controllably consistent manner described above.

Although not expressly illustrated, one skilled in the art will appreciate that other designs are also contemplated. For example, there may be three or more separate balloons that each circumscribes a portion of the surface of the container. Alternatively, there may be a single balloon having a gap in the center (similar to a doughnut) into which the container is disposed and that single balloon is inflated to constrict the surface of the container.

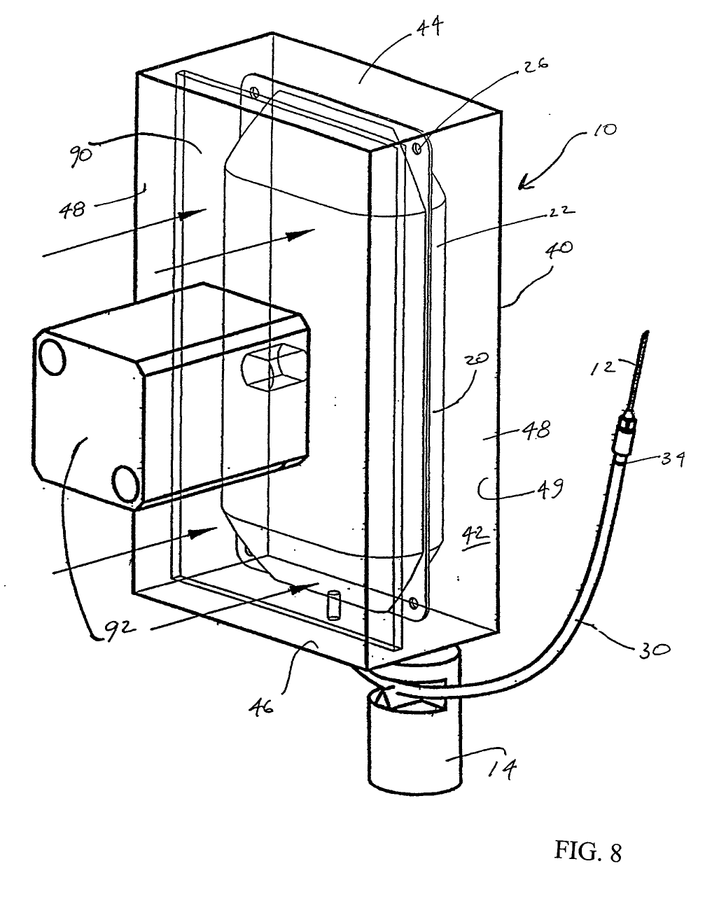

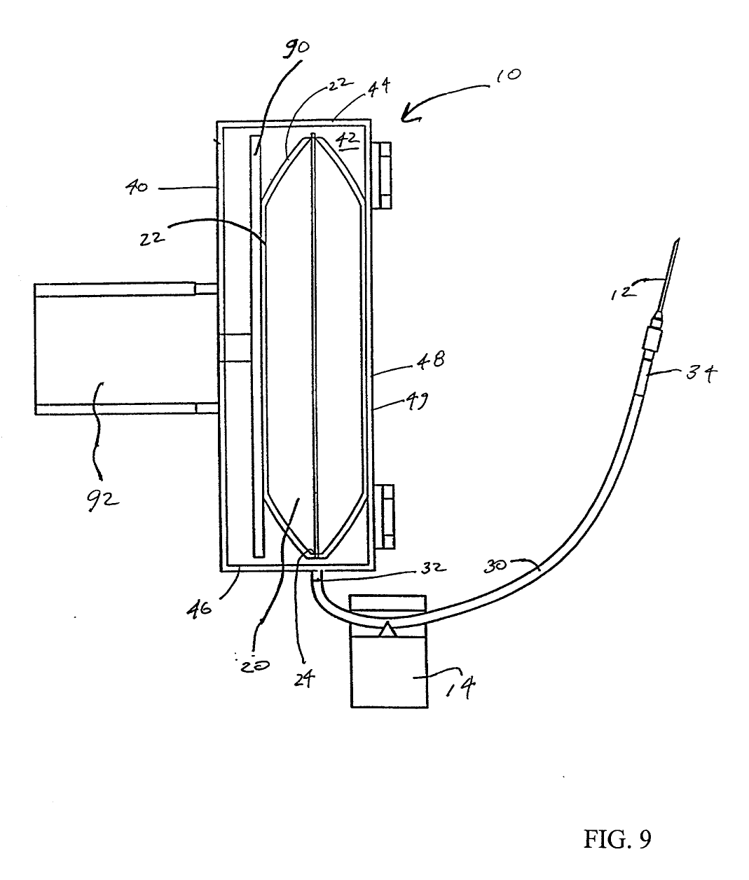

Referring now to FIGS. 8 and 9, a fourth embodiment of the present invention is illustrated. The method or means to compress the container 20 comprises a moveable plate 90 (or some other force-applying structure) and a cylinder 92 for moving that plate 90 to contact a portion of the container 20. The plate 90 is preferably a flat metal structure, but other hard materials of different shapes may be employed. The plate 90 is disposed facing one wall 48 of the housing 40 and at least a portion of the deformable surface 22 of the container 20 is disposed intermediate the plate 90 and the facing wall 49.

The cylinder 92 may embody any type of means for controllably driving or moving the plate 90. One specific type of cylinder 92 is a Series CA1, 80 mm bore diameter-driving cylinder available from SMC Pneumatics Inc. of Indianapolis, Ind. Other exemplary types of cylinders include electrically-operated solenoids and cylinders.

One skilled in the art will appreciate that in this embodiment, there is also no requirement that the interior 42 of the housing 40 be sealable or pressurized. As such, the housing 40 may be as simple as comprising a single wall 48, the wall 49 facing the plate 90. However, as illustrated in FIGS. 8 and 9, the housing 40 comprises a bottom 46 and a plurality of walls 48 circumscribing the container 20 and the plate 90. The illustrated design also includes the dispensing tube 30 traversing through the bottom 46 and including a needle 12 attached to its second end 34.

During operation, the container 20 is positioned within the interior 42 between the plate 90 and the facing wall 49. The cylinder 92 is actuated and the plate 90 is controllably moved to and against the container 20 holding the fluid, such as liquid monomer. When the cylinder 92 moves the plate 90 toward the container 20, he facing wall 49 restrains the container 20 so that fluid located within the container 20 is forced through its outlet 24. That is, the container 20 is squeezed between the plate 90 and the facing wall 49, causing the surface 22 of the container 20 to deform. Deformation of the container 20, as discussed above for the other embodiments, forces the fluid out of the container 20 through the dispensing tube 30 and out the dispensing needle 12 into the mold or other structure. Consistent flow of fluid out of the container 20 and through the dispensing tube 30 is achieved by controlling the cylinder 92 and, thus, the force applied to the container 20 by the plate 90.

Alternatively, multiple plates (not shown) may be provided. For example, the plates may be arranged in a side-by-side relationship and move in synchronization with each other. As another example, the plates may be oriented facing each other so that one plate is in the same position as the facing wall discussed above.

Although the present invention has been described with reference to specific details of certain embodiments thereof, it is not intended that such details should be regarded as limitations upon the scope of the invention except as and to the extent that they are included in the accompanying claims. For example, although the present invention has been discussed in the exemplary context of injecting monomer in a lens forming process, the present invention has applicability to other processes in other arts and industries.

What is claimed is:

1. A fluid-dispensing apparatus, comprising:
a. a container for holding fluid therein, the container having an outlet, wherein the container has a surface and at least a portion of the surface is deformable;
b. a housing having an interior where at least a portion of the deformable surface of the container is located; and
c. means for compressing at least a portion of the deformable surface of the container that is located within the interior of the housing.

2. The apparatus of claim 1, further comprising a dispensing tube having a first end contacting and in fluid communication with the outlet of the container and an opposed second end.

3. The apparatus of claim 2, further comprising a needle in fluid communication with the second end of the dispensing tube so that fluid exiting the container flows through and out of the needle.

4. The apparatus of claim 2, further comprising a valve in communication with the dispensing tube intermediate its first and second ends, the valve movable between a shut position, in which fluid is hindered from traversing through the dispensing tube, and an open position, in which fluid flow more freely occurs through the dispensing tube.

5. The apparatus of claim 2, wherein the interior of the housing is a closed and substantially fluid-tight volume having an inlet orifice and a sealable aperture through which a portion of the dispensing tube intermediate its first and second ends is disposed, and
wherein the compressing means comprises a pressurized fluid source in fluid communication with the inlet orifice,
whereby when fluid from the pressurized fluid source is added into the interior of the housing through its inlet orifice, pressure within the interior of the housing increases, the deformable portion of the container moves inwardly, and fluid within the container is forced through its outlet to enter the dispensing tube and traverse toward its second end.

6. The apparatus of claim 5, wherein the housing has a top, a spaced-apart bottom, and a plurality of walls abutting each other and interconnecting the top and bottom, one wall having a sealable door therethrough, the sealable door movable between an open position, in which the container may be accessed within the interior of the housing, and a shut position, in which the interior is substantially sealed from ambient.

7. The apparatus of claim 5, wherein the housing comprises:
a. an outer shell having an inside surface;
b. a liner disposed within and substantially circumscribed by the inside surface of the outer shell, the liner forming the closed volume of the housing in which the container is positioned.

8. The apparatus of claim 7, wherein the outer shell is formed of a substantially rigid material and the liner is formed of a flexible and fluid-impervious material.

9. The apparatus of claim 1, wherein the interior of the housing circumscribes at least a portion of the deformable surface of the container, and
wherein the compressing means comprises:
a. at least one inflatable balloon at least partially disposed within the interior of the housing adjacent the container; and
b. a pressurized fluid source in fluid communication with each balloon,
whereby fluid from the pressurized fluid source expands the balloon, which correspondingly compresses a portion of the deformable surface of the container located within the interior of the housing inwardly so that fluid within the container is forced through its outlet.

10. The apparatus of claim 9, wherein there are at least two balloons and the container is disposed intermediate the balloons.

11. The apparatus of claim 9, wherein the housing comprises a bottom and a plurality of walls circumscribing the container and the balloon.

12. The apparatus of claim 11, further comprising a dispensing tube having a first end in fluid communication with the outlet of the container and an opposed second end, and
wherein a portion of the dispensing tube intermediate its first and second ends passes through the bottom of the housing,
whereby, when the balloon applies pressure to a portion of the deformable surface of the container, fluid within the container exits into the first end of the dispensing tube, traverses therethrough, and then flows out of its second end.

13. The apparatus of claim 1, wherein the interior of the housing comprises at least one wall, and
wherein the compressing means comprises:
a. a moveable plate disposed facing one wall of the housing, wherein a portion of the deformable surface of the container is disposed intermediate the plate and the facing wall; and
b. a cylinder for moving the plate to contact a portion of the container, the container restrained by the facing wall whereby fluid located within the container is forced through its outlet.

14. The apparatus of claim 13, wherein, wherein the housing comprises a bottom and a plurality of walls circumscribing the container and the plate.

15. The apparatus of claim 14, further comprising a dispensing tube having a first end in fluid communication with the outlet of the container and an opposed second end, and
wherein a portion of the dispensing tube intermediate its first and second ends passes through the bottom of the housing,
whereby, when the plate applies pressure to the container, fluid within the container exits into the first end of the dispensing tube, traverses therethrough, and then flows out of its second end.

16. A fluid-dispensing apparatus, comprising:
a. a fluid;
b. a container for holding the fluid therein, the container having an outlet through which the fluid exits the container, wherein the container has a surface and at least a portion of the surface is deformable;
c. a housing having an interior where at least a portion of the deformable surface of the container is located; and
d. means for compressing at least a portion of the deformable surface of the container that is located within the interior of the housing, wherein compression of the surface of the container forces at least a portion of the fluid out of its outlet.

17. The apparatus of claim 16, wherein the fluid is a monomer.

18. The apparatus of claim 16, farther comprising a dispensing tube having a first end in fluid communication with the outlet of the container and an opposed second end, wherein, when the compressing means applies pressure to a portion of the deformable surface of the container, some of the fluid within the container exits into the first end of the dispensing tube, traverses therethrough, and then flows out of its second end.

19. The apparatus of claim 18, further comprising a needle in fluid communication with the second end of the dispensing tube so that fluid exiting the container flows through and out of the needle.

20. A fluid-dispensing apparatus, comprising:
a. a container for holding fluid therein, the container having an outlet, wherein the container has a surface and at least a portion of the surface is deformable;
b. a dispensing tube having a first end connected to and in fluid communication with the outlet of the container and an opposed second end, the first and second ends in fluid communication with each other;
c. a housing having an interior for holding the container, wherein the interior is a closed and substantially fluid-tight volume having an inlet orifice and a sealable aperture through which a portion of the dispensing tube intermediate its first and second ends is disposed, and
d. a pressurized fluid source in fluid communication with the inlet orifice of the housing,
whereby, when fluid from the pressurized fluid source is added into the interior of the housing through its inlet orifice, pressure within the interior of the housing increases, the deformable portion of the container moves inwardly, and fluid within the container is forced through its outlet to enter the dispensing tube and traverse toward its second end.

21. The apparatus of claim 20, wherein the housing has a top, a spaced-apart bottom, and a plurality of walls abutting each other and interconnecting the top and bottom, one wall having a sealable door therethrough, the sealable door movable between an open position, in which the container may be accessed within the interior of the housing, and a shut position, in which the interior is substantially sealed from ambient.

22. The apparatus of claim 20, wherein the housing comprises:
a. an outer shell having an inside surface;
b. a liner disposed within and substantially circumscribed by the inside surface of the outer shell, the liner forming the closed volume of the housing in which the container is positioned.

23. The apparatus of claim 22, wherein the outer shell is formed of a substantially rigid material and the liner is formed of a flexible and fluid-impervious material.

24. A fluid-dispensing apparatus, comprising:
a. a container for holding fluid therein, the container having an outlet, wherein the container has a surface and at least a portion of the surface is deformable;
b. a housing having an interior that circumscribes at least a portion of the deformable surface of the container;
c. at least one inflatable balloon at least partially disposed within the interior of the housing adjacent the container; and
d. a pressurized fluid source in fluid communication with each balloon,
whereby fluid from the pressurized fluid source expands each balloon, which correspondingly compresses a portion of the deformable surface of the container inwardly.

25. The apparatus of claim 24, wherein there are at least two balloons and the container is disposed intermediate the balloons.

26. The apparatus of claim 24, wherein the housing comprises a bottom and a plurality of walls circumscribing the container and each balloon.

27. The apparatus of claim 26, further comprising a dispensing tube having a first end in fluid communication with the outlet of the container and an opposed second end,
wherein a portion of the dispensing tube intermediate its first and second ends passes through the bottom of the housing.

28. A fluid-dispensing apparatus, comprising:
a. a container for holding fluid therein, the container having an outlet, wherein the container has a surface and at least a portion of the surface is deformable;
b. a housing having an interior including at least one wall adjacent to which the container is disposed;
c. a moveable plate disposed facing one wall of the housing, wherein a portion of the deformable surface of the container is disposed intermediate the plate and the facing wall; and
d. a cylinder for moving the plate to contact a portion of the container,
whereby the container is restrained by the facing wall of the housing so that fluid located within the container is forced through its outlet.

29. The apparatus of claim 28, wherein, wherein the housing comprises a bottom and a plurality of walls circumscribing the container and the plate,
wherein the container further comprises a dispensing tube having a first end in fluid communication with the outlet of the container and an opposed second end, and
wherein a portion of the dispensing tube intermediate its first and second ends passes through the bottom of the housing.

30. A method of dispensing a fluid, comprising:
a. providing a container that holds the fluid therein, the container having an outlet through which the fluid exits the container and a surface, wherein at least a portion of the surface is deformable;
b. locating at least a portion of the deformable surface of the container in an interior of a housing; and
c. compressing at least a portion of the deformable surface of the container that is located within the interior of the housing so that the compressing results in at least a portion of the fluid flowing out of its outlet.

31. The method of claim 30, wherein the fluid is a monomer.

32. The method of claim 30, further comprising connecting a first end of a dispensing tube to the outlet of the container to be in fluid communication therewith, the dispensing tube having an opposed second end in fluid communication with its first end, wherein, when the fluid within the container exits the opening of the container, the fluid flows into the first end of the dispensing tube, traverses therethrough, and then flows out of its second end.

33. The method of claim 30, further comprising attaching a needle to the second end of the dispensing tube so that fluid flowing through the dispensing tube flows through and out of the needle.
